(19) United States
(12) Patent Application Publication
(10) Pub. No.: US 2015/0375983 A1
(43) Pub. Date: Dec. 31, 2015

(54) Drip Collection Device

(71) Applicant: James Code, Drumbo (CA)

(72) Inventor: James Code, Drumbo (CA)

(21) Appl. No.: 14/317,470

(22) Filed: Jun. 27, 2014

(51) Int. Cl. B67D 7/32

(52) U.S. Cl. CPC B67D 7/3209

(57) ABSTRACT

A drip collection device collects and contains drippings from a vehicle, such as water, dirt and like material. The device includes a container having a bottom wall and a perimeter wall coupled to and extending upwardly from the bottom wall defining an interior space configured for holding drippings from a vehicle when the vehicle is positioned above the container. A panel is coupled to and extends across the container. The panel has a top surface defining a platform spaced above the bottom wall configured for receiving the vehicle thereon. The panel has a plurality of drain holes extending therein configured for permitting the drippings from the vehicle to pass into the interior space. A ramp is coupled to a first end of the panel. The ramp slants upwardly toward the panel to permit the vehicle to be driven upwardly onto the platform.

### BACKGROUND OF THE DISCLOSURE

### Field of the Disclosure

The disclosure relates to drip containment assemblies and more particularly pertains to a new drip containment assembly for collecting and containing drippings from a vehicle, such as water, dirt and like material.

### SUMMARY OF THE DISCLOSURE

An embodiment of the disclosure meets the needs presented above by generally comprising a container having a bottom wall and a perimeter wall coupled to and extending upwardly from the bottom wall defining an interior space configured for holding drippings from a vehicle when the vehicle is positioned above the container. A panel is coupled to and extends across the container. The panel has a top surface defining a platform spaced above the bottom wall configured for receiving the vehicle thereon. The panel has a plurality of drain holes extending therein configured for permitting the drippings from the vehicle to pass into the interior space. A ramp is coupled to a first end of the panel. The ramp slants upwardly toward the panel to permit the vehicle to be driven upwardly onto the platform.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a drip collection device according to an embodiment of the disclosure.

FIG. 2 is a top rear side perspective view of an embodiment of the disclosure.

FIG. 3 is an exploded top perspective view of an embodiment of the disclosure.

FIG. 4 is an exploded side view of an embodiment of the disclosure.

FIG. 5 is a top view of an embodiment of the disclosure.

FIG. 6 is a rear in-use view of an embodiment of the disclosure.

### DESCRIPTION OF THE PREFERRED EMBODIMENT

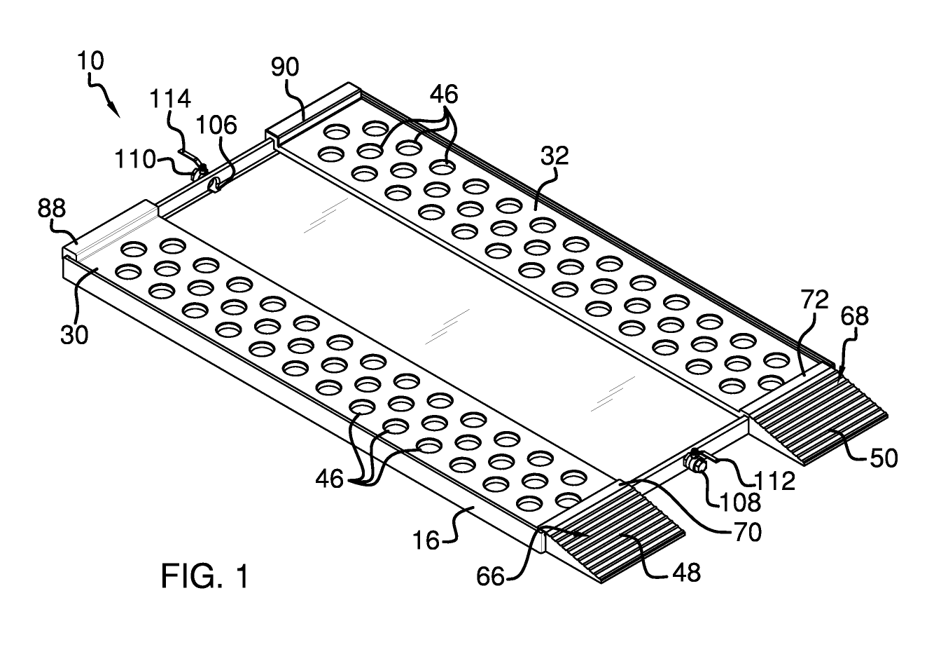

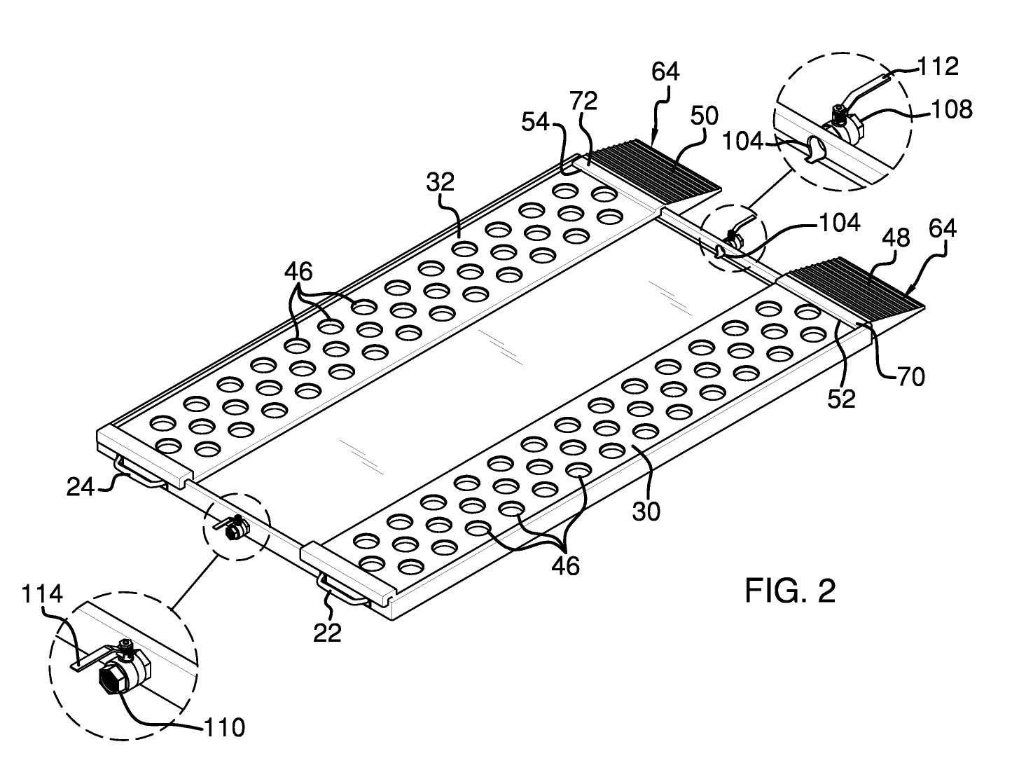

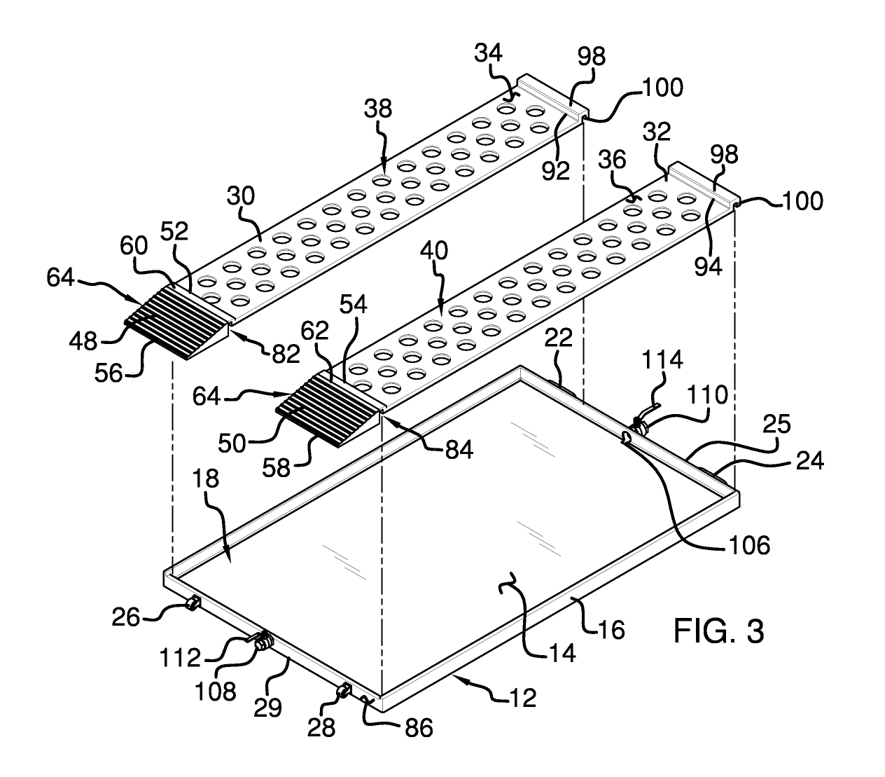

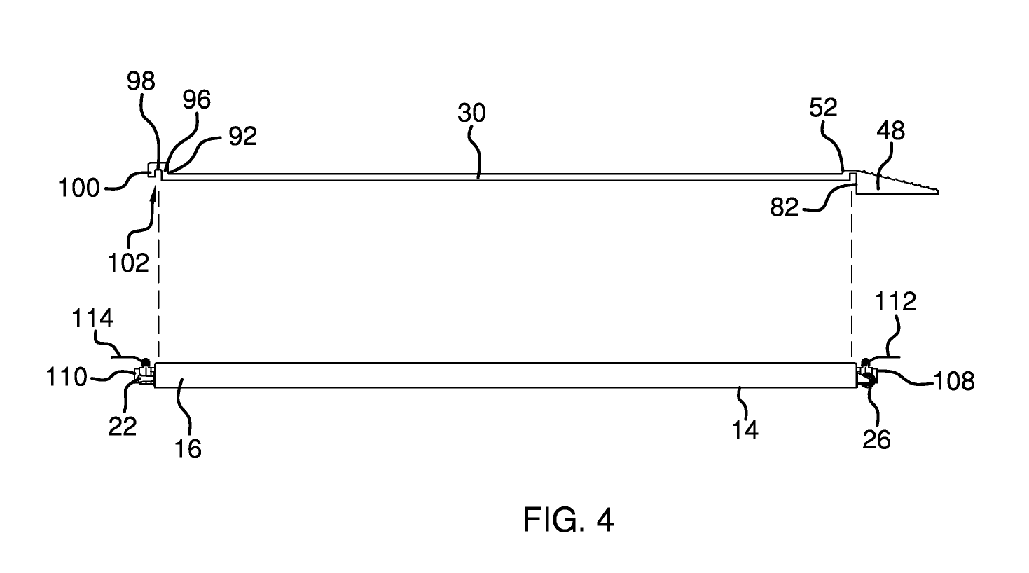

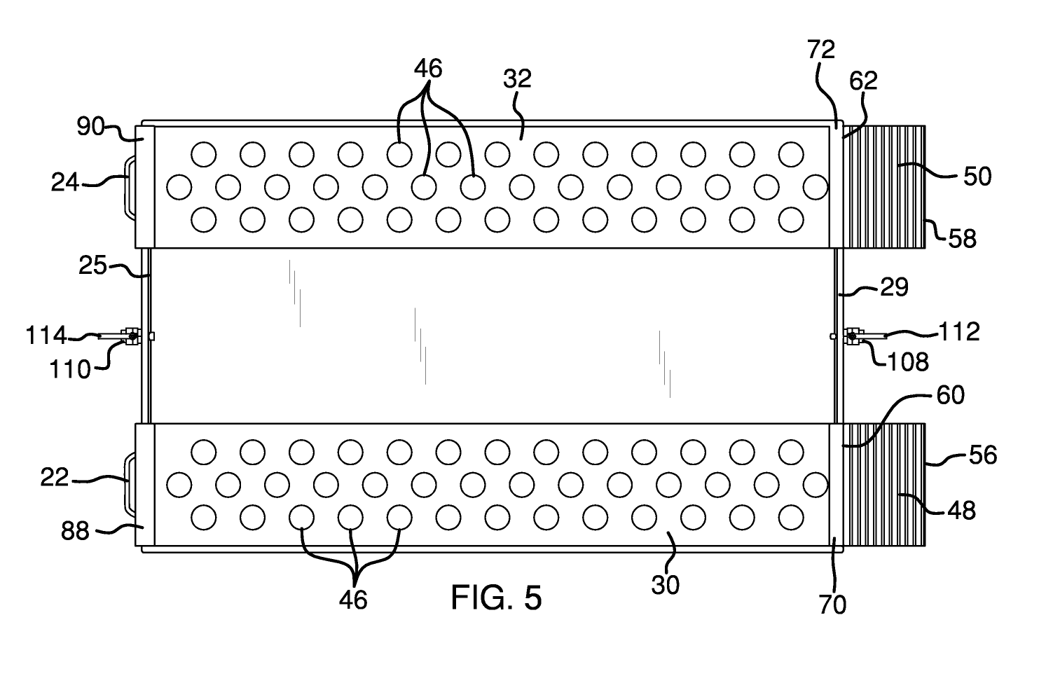

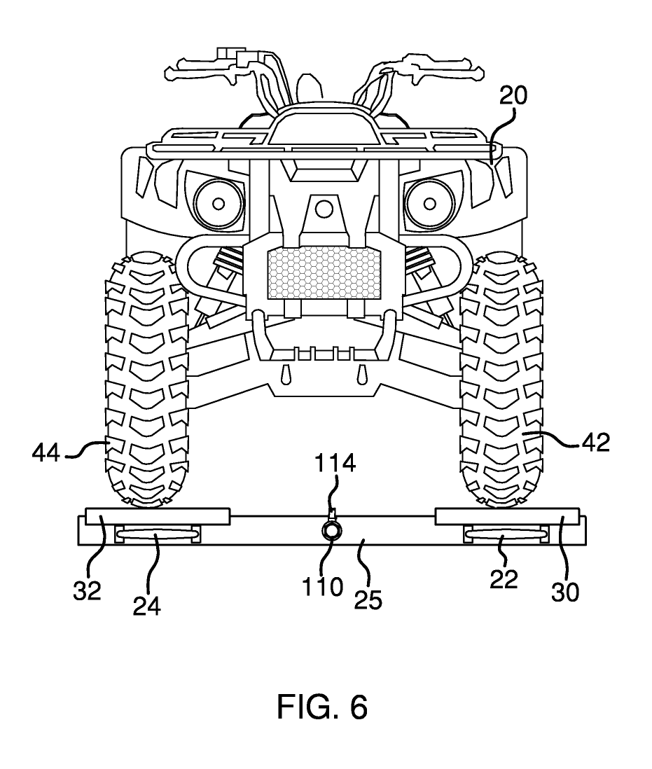

With reference now to the drawings, and in particular to FIGS. 1 through 6 thereof, a new drip containment assembly embodying the principles and concepts of an embodiment of the disclosure and generally designated by the reference numeral 10 will be described.

As best illustrated in FIGS. 1 through 6, the drip collection device 10 generally comprises a container 12 having a bottom wall 14 and a perimeter wall 16 coupled to and extending upwardly from the bottom wall 14 defining an interior space 18 configured for holding drippings from a vehicle 20 when the vehicle 20 is positioned above the container 12. The vehicle 20 may comprise an ATV, a snowmobile, or the like. A plurality of handles 22, 24 is coupled to a first side 25 of the perimeter wall 16. A plurality of wheels 26, 28, casters or the like is coupled to the container 12 to facilitate transportation of the device 10 on a ground surface. The wheels 26, 28 are coupled to a second side 29 of the perimeter wall 16 opposite the first side 25 of the perimeter wall 16. The container 12 and handles 22, 24 are comprised of a rigid material, such as metal, plastic or the like. The container 12 may have a length extending from the first side 25 to the second side 29 of the perimeter wall 16 measuring between approximately 200.0 cm and 275.0 cm. The container 12 may have a width extending between approximately 120.0 cm and 170.0 cm. A height from the bottom wall 14 to a top edge of the perimeter wall 16 may measure between approximately 7.0 cm and 18.0 cm.

A pair of panels 30, 32 is coupled to and extends across the container 12. The panels 30, 32 are positioned in spaced parallel relationship relative to each other. Each of the panels 30, 32 has a top surface 34, 36 defining a respective platform 38, 40 spaced above the bottom wall 14 wherein each of the platforms 38, 40 is configured for receiving an associated wheel 42, 44 of the vehicle 20 thereon. Each panel 30, 32 has a plurality of drain holes 46 extending therein configured for permitting the drippings from the vehicle 20 to pass through the panels 30, 32 into the interior space 18.

A pair of ramps 48, 50 is provided and each is coupled to a first end 52, 54 of a respective one of the panels 30, 32. Each ramp 48, 50 has a distal end 56, 58 and a proximal end 60, 62 with respect to the respective panel 30, 32. Each ramp 48, 50 slants upwardly from the distal end 56, 58 to the proximal end 60, 62 of the respective panel 30, 32 to permit the vehicle 20 to be driven upwardly onto the platforms 38, 40. A plurality of ridges 64 is positioned on an upper surface 66, 68 of each ramp 48, 50. Each of the panels 30, 32 may be integrally coupled to a respective one of the ramps 48, 50. The ramps 48, 50 and the panels 30, 32 may be removably coupled to the container 12.

A pair of first brackets 70, 72 is provided and each is coupled to a respective one of the panels 30, 32. Each of the first brackets 70, 72 extends from the first end 52, 54 of the respective panel 30, 32 such that each first bracket 70, 72 extends over and engages the perimeter wall 16 of the container 12 when the respective panel 30, 32 is coupled to the container 12. A rear end 82, 84 of each ramp 48, 50 abuts an exterior surface 86 of the perimeter wall 16 when each associated first bracket 70, 72 is coupled to the container 12.

A pair of second brackets 88, 90 is provided and each is coupled to a respective one of the panels 30, 32. Each second bracket 88, 90 extends from a second end 92, 94 of the respective panel 30, 32 such that each second bracket 88, 90 extends over and engages the perimeter wall 16 of the container 12 when the respective panel 30, 32 is coupled to the container 12. Each second bracket 88, 90 has a planar first section 96, a planar second section 98 and a planar third section 100. The planar second section 98 is coupled to and extends between the planar first section 96 and the planar third section 100. Each planar first section 96 extends upwardly from the respective platform 38, 40. The planar first section 96 and the planar third section 100 are parallel with respect to each other. The planar second section 98 is transverse relative to each of the planar first section 96 and the planar third section 100. Each second bracket 88, 90 forms a gap 102 between the planar first section 96, the planar second section 98 and the planar third section 100. A thickness of each gap 102 is equivalent to a thickness of the perimeter wall 16 wherein each second bracket 88, 90 is secured to the container 12 when the perimeter wall 16 is received in the associated gap 102.

A plurality of drain ports 104, 106 extend through the perimeter wall 16. A plurality of hose attachments 108, 110 is provided each being fluidly coupled to an associated one of the drain ports 104, 106. Each hose attachment 108, 110 is configured for coupling to a hose. A plurality of valves 112, 114 is also provided. Each of the valves 112, 114 is fluidly coupled to an associated one of the hose attachments 108, 110 wherein each valve 112, 114 is configured to regulate a flow of the drippings through the associated drain port 104, 106.

In use, the vehicle 20 is driven up the ramps 48, 50 onto the platforms 38, 40. Drippings from the vehicle 20, such as mud, snow and other debris, falls into the interior space 18 of the container 12 through the drain holes 46. In this manner, the container 12 collects and contains the drippings to keep a garage floor or other surface clean and dry. Hoses are coupled to the hose attachments 108, 110. The valves 112, 114 are opened to allow the drippings to be drained from the container 12 through the drain ports 104, 106.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A drip collection device comprising:
a container having a bottom wall and a perimeter wall coupled to and extending upwardly from said bottom wall defining an interior space configured for holding drippings from a vehicle when the vehicle is positioned above said container;
a panel coupled to and extending across said container, said panel having a top surface defining a platform spaced above said bottom wall wherein said platform is configured for receiving the vehicle thereon, said panel having a plurality of drain holes extending therein configured for permitting the drippings from the vehicle to pass through said panel into said interior space; and
a ramp coupled to a first end of said panel, said ramp having a distal end and a proximal end with respect to said panel, said ramp slanting upwardly from said distal end to said proximal end of said panel to permit the vehicle to be driven upwardly onto said platform.

2. The device of claim 1, further comprising said panel being one of a pair of said panels, each of said panels being coupled to and extending across said container, said panels being positioned in spaced parallel relationship relative to each other, each of said panels having a top surface defining a respective platform spaced above said bottom wall wherein each said platform is configured for receiving an associated wheel of the vehicle thereon, each said panel having a plurality of drain holes extending therein configured for permitting the drippings from the vehicle to pass through said panels into said interior space.

3. The device of claim 2, further comprising said ramp being one of a pair of said ramps, each said ramp being coupled to said first end of a respective one of said panels, each said ramp slanting upwardly toward said panel to permit the vehicle to be driven upwardly onto said platforms.

4. The device of claim 1, further comprising a plurality of ridges positioned on an upper surface of said ramp.

5. The device of claim 1, further comprising said ramp and said panel being integrally coupled together.

6. The device of claim 5, further comprising said ramp and said panel being removably coupled to said container.

7. The device of claim 6, further comprising:
a first bracket coupled to said panel, said first bracket extending from said first end of said panel such that said first bracket extends over and engages said perimeter wall of said container when said panel is coupled to said container; and
a second bracket coupled to said panel, said second bracket extending from a second end of said panel such that said second bracket extends over and engages said perimeter wall of said container when said panel is coupled to said container.

8. The device of claim 7, further comprising a rear end of said ramp abutting an exterior surface of said perimeter wall when said first bracket is coupled to said container.

9. The device of claim 7, further comprising:
said second bracket having a planar first section, a planar second section and a planar third section, said planar second section being coupled to and extending between said planar first section and said planar third section, said planar first section extending upwardly from said platform, said planar first section and said planar third section being parallel with respect to each other, said planar second section being transverse relative to each of said planar first section and said planar third section; and
said second bracket forming a gap between said planar first section, said planar second section and said planar third section, a thickness of said gap being equivalent to a thickness of said perimeter wall wherein said second bracket is secured to said container when said perimeter wall is received in said gap.

10. The device of claim 1, further comprising at least one handle coupled to said perimeter wall of said container.

11. The device of claim 1, further comprising a plurality of wheels coupled to said container to facilitate transportation of said device on a ground surface.

12. The device of claim 11, further comprising at least one handle coupled to a first side of said perimeter wall, said wheels being coupled to a second side of said perimeter wall opposite said first side of said perimeter wall.

13. The device of claim 1, further comprising said container a drain port extending through said perimeter wall.

14. The device of claim 13, further comprising a hose attachment fluidly coupled to said drain port, said hose attachment being configured for coupling to a hose.

15. The device of claim 14, further comprising a valve fluidly coupled to said hose attachment wherein said valve is configured to regulate a flow of the drippings through said drain port.

16. A drip collection device comprising:
a container having a bottom wall and a perimeter wall coupled to and extending upwardly from said bottom wall defining an interior space configured for holding drippings from a vehicle when the vehicle is positioned above said container;
a plurality of handles coupled to a first side said perimeter wall;
a plurality of wheels coupled to said container to facilitate transportation of said device on a ground surface, said wheels being coupled to a second side of said perimeter wall opposite said first side of said perimeter wall;
a pair of panels coupled to and extending across said container, said panels being positioned in spaced parallel relationship relative to each other, each of said panels having a top surface defining a respective platform spaced above said bottom wall wherein each said platform is configured for receiving an associated wheel of the vehicle thereon, each said panel having a plurality of drain holes extending therein configured for permitting the drippings from the vehicle to pass through said panels into said interior space;
a pair of ramps each coupled to a first end of a respective one of said panels, each said ramp having a distal end and a proximal end with respect to said respective panel, each said ramp slanting upwardly from said distal end to said proximal end of said respective panel to permit the vehicle to be driven upwardly onto said platforms, a plurality of ridges positioned on an upper surface of each said ramp, each of said panels being integrally coupled to a respective one of said ramps, said ramps and said panels being removably coupled to said container;
a pair of first brackets, each of said first brackets being coupled to a respective one of said panels, each said first bracket extending from said first end of said respective panel such that each said first bracket extends over and engages said perimeter wall of said container when said respective panel is coupled to said container, a rear end of each said ramp abutting an exterior surface of said perimeter wall when each said associated first bracket is coupled to said container;
a pair of second brackets, each of said second brackets being coupled to a respective one of said panels, each said second brackets extending from a second end of said respective panel such that each said second bracket extends over and engages said perimeter wall of said container when said respective panel is coupled to said container, each said second bracket having a planar first section, a planar second section and a planar third section, said planar second section being coupled to and extending between said planar first section and said planar third section, each said planar first section extending upwardly from said respective platform, said planar first section and said planar third section being parallel with respect to each other, said planar second section being transverse relative to each of said planar first section and said planar third section;
each said second bracket forming a gap between said planar first section, said planar second section and said planar third section, a thickness of each said gap being equivalent to a thickness of said perimeter wall wherein each said second bracket is secured to said container when said perimeter wall is received in said associated gap;
a plurality of drain ports extending through said perimeter wall;
a plurality of hose attachments, each of said hose attachments being fluidly coupled to an associated one of said drain ports, each said hose attachment being configured for coupling to a hose; and
a plurality of valves, each of said valves being fluidly coupled to an associated one of said hose attachments wherein each said valve is configured to regulate a flow of the drippings through said associated drain port.
